(19) United States
(12) Patent Application Publication
(10) Pub. No.: US 2025/0281851 A1
(43) Pub. Date: Sep. 11, 2025

(54) APPRATUS AND SYSTEM FOR DENSITY BASED DISTILLATION

(71) Applicant: Jacob Barnes, Madison, WI (US)

(72) Inventor: Jacob Barnes, Madison, WI (US)

(21) Appl. No.: 19/075,138

(22) Filed: Mar. 10, 2025

Related U.S. Application Data
(60) Provisional application No. 63/563,536, filed on Mar. 11, 2024.

(51) Int. Cl. B01D 17/02; B01D 21/02; C02F 1/00; C02F 1/40

(52) U.S. Cl. CPC B01D 17/0214; B01D 21/02; C02F 1/40; C02F 2001/007

(57) ABSTRACT

A device for distillation of a medium is disclosed. The device comprises a shell. At least one distillation body is located in a cavity defined by the shell. The shell comprises an opening for entrance of the medium into the cavity. The shell further compromises a central mechanism or exit for removal of components of a first density. The shell comprises a second exit point for removal of components of a second density, a snorkel is applied for entry of medium into the cavity, the distillation device is fluidly connected to at least one collection container for a collection of distilled components, more than one distillation device is combined to provide for a system of distillation of multiple components. In another aspect of the invention, a method of application of the distillation device is provided.

### CROSS-REFERENCE TO RELATED APPLICATIONS

This application claims the priority as a non-provisional application of U.S. Application No. 63/563,536 filed Mar. 11, 2024, the entire contents of which is hereby incorporated by reference in its entirety herein.

### FIELD

The present inventions relate to the field of distillation. The present inventions more specifically relate to distilling of a fluid or gas through a distillation medium where the medium filtered has a different density than the distillation medium.

### BACKGROUND

Purification of water and gases has been with civilized culture through time from the Nabateans to the present. At present mechanisms involve non-woven roll media, paper filters, fabric filters, cotton-wool filters, sand filters, and asbestos filters among others. Such filters have been applied for the distillation of water and gases for maintaining fluid flow and preventing wear on machine parts, among other applications such as food purification.

With respect to fluid distillation for fluid flow, modern societies with communities in arid lands bring water to these arid lands to support agriculture and economic development. The United States of America for example manages 8,000 miles of canals which deliver water across the Western United States, serving over 30 million customers and 10 million acres of farmland that produce 60% of the nation's vegetables and 25% of its fruits and nuts.

However, aquatic vegetation can and does grow in many canals and waterways providing such water to communities. The aquatic vegetation can obstruct water flow, degrade water quality, and limit access for inspection and maintenance of the canal or waterway. Where the growth of aquatic vegetation is greater, the operating elevations of the water levels can increase which can result in a risk of failure to the canal or waterway.

There are various mechanical and chemical mechanisms in the art for addressing such aquatic vegetation. However, these existing mechanisms for managing aquatic vegetation have drawbacks. Mechanical mechanisms involve removal of the aquatic vegetation. Such mechanical mechanisms are costly to implement and maintain, and are labor intensive. Further these mechanisms can disrupt embankments and create debris and sedimentation issues. Chemical mechanical mechanisms involve the chemical deterioration of aquatic vegetation. These chemical mechanisms are limited for aquatic environments. Though not as labor intensive as mechanical mechanisms, the chemical mechanisms in the art can be costly. Further, such chemical mechanisms can present safety risks to humans and wildlife, and undesirable downstream effects from environmental deterioration to contamination of drinking supplies and produce.

As to gas purification and separation, in the art such is carried out in one of membrane separation or diffusion from an area of high concentration to an area of low concentration. However, along with wear on the polymers of both systems, the cost to install such systems may prohibit the application.

In other words, known fluid distillation mechanisms and gas separation mechanisms have disadvantages. The ability to create the desired fluid flow, where aquatic vegetation is present, is limited to aggressive physical or chemical removal of the aquatic vegetation. Further, the ability to create a gas purification and separation may be cost prohibitive for large scale operations in view of the initial and operational cost structure in the art.

Accordingly, there is a need for a distillation mechanism with reduced operational impact on the environment and has a lower initial and operational cost structure. For example many distillation methods known in the art are very energy intensive, with the apparatus heating or cooling the substance to achieve distillation.

### Outline of Basic and Other Advantageous Features

It would be desirable to provide a distillation mechanism which could passively harvest surface pollution having a different density than that of water from flowing or churning streams, lakes and seas.

It would be desirable to provide a distillation mechanism which could ‘mine’ fluids from other fluids, extracting valuable commodities.

It would be desirable to provide a distillation mechanism which could distill out pollution from water flowing through human infrastructure with minimal effort (non-exclusive examples being applications in dams, water treatment plants, swimming pools, discharge pipes, storms, and storm sewers).

It would be desirable to provide a distillation mechanism which could harvest gas waste from wells (a non-exclusive example being the extraction of noble gases from wells located near hot springs and mineral springs).

It would be desirable to provide a distillation mechanism which could operate as a heat exchanger applying heat derived from sources on the environment.

Other advantages and/or advantageous features will become apparent to those skilled in the art, once the disclosure has been more fully shown or described. Such outlining of advantageous features is not to be construed as a limitation of applicant's disclosure but are merely aimed to suggest some of the many benefits that may be realized by the apparatus and method of the present application and with its many embodiments.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one construction, a distillation device is disclosed. The distillation device comprises: a shell defining a cavity, a solution positioned in the cavity, with the solution being of a first density; an first opening for addition of a distilling medium to the solution with the distilling medium having a second density; a second opening positioned lower than the first opening, with the second opening defined by a support mechanism, with the support mechanism attached to the shell; and the second opening providing for an exit of the distilling medium.

The distillation device may further comprise: the shell has a curved shape; the curved shape is concave with respect to a surface, with the curved shape being a parabolic shape; the solution is one of a gas and an oil; a second solution having a third density for suspension of a distilling medium component having a fourth density, with the fourth density being less than the third density; the third density is less than the second density; a pump for insertion of the distilling medium into the solution; the support mechanism is one or more tethers extended from the shell; the first opening is connected to an extension having an opening positioned proximate to a fluid line of a fluid in which the distillation device is positioned; the shell is fluidly connected to a plurality of solutions, with each solution of the plurality of solutions having a different density; a first distilling medium component having a first distilling medium component density is suspended in a first solution of the plurality of solutions and a second distilling medium component having a second distilling medium component density is suspended in a second solution of the plurality of solutions; and the shell is a tubular structure.

In another construction, a system of distillation is disclosed. The system of distillation comprises a plurality of distillation devices, with each of the plurality of distillation devices having: a shell defining a cavity; a solution positioned in the cavity, with the solution being of a first density; an first opening for addition of a distillation medium to the solution with the distillation medium having a second density; an second opening positioned lower than the first opening, with the second opening defined by a support mechanism, with the support mechanism connected to the shell; and the second opening providing for an exit of the distilling medium. The system of distillation further comprises each of the plurality of distillation devices in fluid connection.

The distillation device may further comprise: the plurality of distillation devices are positioned in a substantially vertical orientation; a first distillation device is positioned closer to a ground than a second distillation device, with the first distillation device having a first distilling medium component and the second distillation device having a second distillation medium component, with the first distillation medium component having a greater density than the second distillation medium component; a gas port for a removal of gas; and a vent hood for capture of the distillation medium.

In another construction, a method of distillation is disclosed. The method of distillation comprises: advancing a distillation medium to an opening of a shell of a distillation device; inserting the distillation medium in a solution positioned in a cavity defined by the shell, with the solution being of a first density; separating a first component of the distillation medium having a second density from a second component of the distillation medium having a third density; pushing the first component of the distillation medium lower than the solution to a mechanism supported by the shell for a removal of the first component of the distillation medium; and housing the second component of the distillation medium one of with or above the solution.

The method of distillation may further comprise: the pushing the first component of the distillation medium lower than the solution comprises the second density being greater than the first density; and the housing the second component of the distillation medium one of with or above the solution comprises the first density being greater than the third density.

These and other features and advantages of devices, methods, and systems according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 is a side cross-sectional view of a first aspect of the distillation device of the invention herein.

FIG. 2 is a side cross-sectional view of a second aspect of the distillation device of the invention herein.

FIG. 3 is a side cross-sectional view of a third aspect of the distillation device of the invention herein.

FIG. 4 is a side cross-sectional view of a fourth aspect of the distillation device of the invention herein, illustrating a suspended component of the distillation device.

FIG. 5 is a side cross-sectional view of a first aspect of a distillation system incorporating the fourth aspect of the distillation device of the invention herein.

FIG. 6 is a side cross-sectional view of a second aspect of the distillation system illustrating the application of multiple units of the fourth aspect of the distillation device of the invention herein, illustrating application as to various levels of a medium.

FIG. 7 is a side cross-sectional view of a third aspect of the distillation system illustrating application of the distillation system at a hydrothermal vent.

FIG. 8 is a side cross-sectional view of a fifth aspect of the distillation device of the invention herein.

FIG. 9 is a perspective view of a sixth aspect of the distillation device of the invention herein.

FIG. 10 is a side cross-sectional view of the sixth aspect of the distillation device of the invention herein.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiment illustrated herein.

Within the scope of this application, it is expressly intended that the various aspects, embodiments, examples, and alternatives set out in the preceding paragraphs, and the claims and/or the following description and drawings, and in particular the individual features thereof, may be taken independently or in any combination. That is, all embodiments and all features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

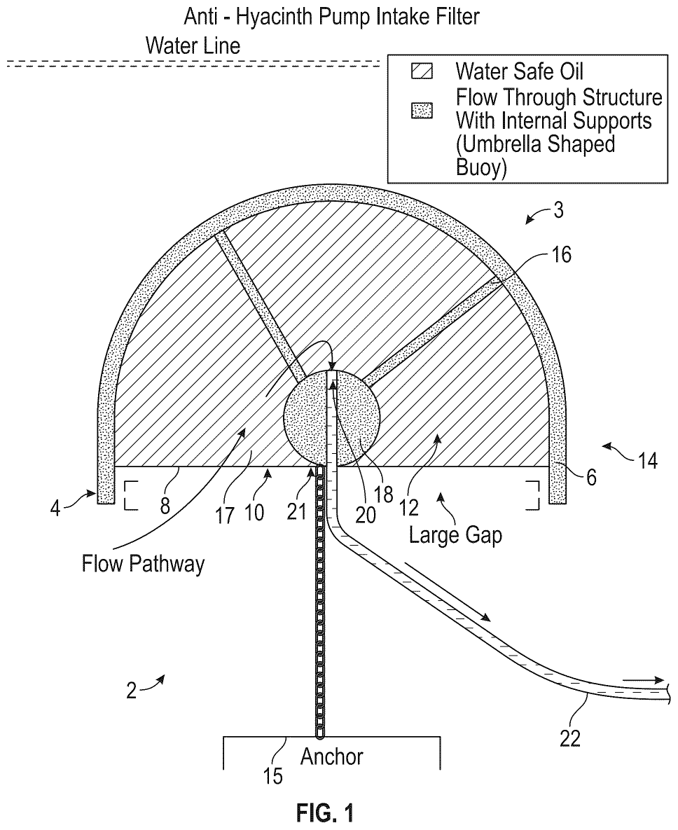

With attention to FIG. 1, a side cross-sectional view of a first aspect of the distillation device 2 of the invention herein is illustrated. The invention includes a medium distillation apparatus 3 and method of operation of the apparatus 3, which applies a variation of Archimedes' distillation. The apparatus comprises an umbrella shaped buoy (buoy) 4. The buoy has a shell structure 6 that defines the umbrella shape. The umbrella shape of the shell is concave with respect to a surface or ground 35 on which the device 2 is anchored or resting on or near or to a downward direction of a flow of distilling medium, gravity. An umbrella shape is paraboloid or parabola. The shell structure 6 has an inner surface and outer surface. The buoy 4 comprises an opening 8 at a first end 10 of the shell structure 6. The shell structure 6, and specifically the inner surface of the shell structure 6, and the opening 8 define a cavity 12 of the buoy 4. The apparatus 3 is placed in a position of operation in a medium 14 such that the opening 8 of the buoy 4 is facing downward. Further, the apparatus 3 is preferably submerged in the medium 14, whether tethered to an anchor 15 resting on a floor of the body in which the medium resides, or via a buoyancy mechanism (not illustrated in the figures). It is understood the medium 14 comprises both distilling medium, which may be but is not limited to water or gas, of a first density and particulate, oils, and gases of a second density, where the first density and the second density are different. A water safe oil 17 is installed in the cavity 12, or alternatively a gas in certain applications. One or more radial supports 16 extend from the inner surface of the shell structure 6 into the cavity towards a central region 21 of the opening 8. The radial supports 16 may be in one piece molded construction with the shell structure 6. Alternatively, the radial supports 16 may be welded to the shell structure 6 or mechanically attached to the shell structure 6. With a radial support first end contacting the shell structure, a radial support second end contacts a central mechanism 18, positioned at the central region 21. The combination of the radial supports 16 position the central mechanism 18 in or proximate to the central region and provide a mechanical resistance to movement of the central mechanism from the central region 21. In a construction of the distillation device 2 mechanical agitator is positioned within the cavity 12 or outside the cavity 12 to create turbulence in the medium 14 within the shell structure 6. The turbulence created then agitates or stirs particulate, oils, and gases into the medium 14 to facilitate better sorting. A construction of the distillation device 2 may comprise passive, shaped inlets positioned through the shell structure 6 or within the cavity to compel incoming particulate, oils, and gases to agitate or stir into the oil layer into the medium 14 as the particulate, oils, and gases pass through distillation device 2.

The central mechanism 18 contains a through hole 20. The through hole extends from a position in the direction the inner surface of the shell structure 6, through hole first position, to a position distal with respect to the inner surface of the shell structure 6, through hole second position. Specifically, the through hole 20 extends in a substantially downward direction through the central mechanism 18. The through hole 20 houses a filter (not illustrated in the figures). A tube 22 is connected to the central mechanism 18 at the through hole second position. The tube extends in a direction away from the apparatus 3.

As illustrated in FIG. 1, a method of applying the apparatus 3 is described. Water, or gas depending upon the medium 14, from the medium 14 enters the cavity 12 through the opening 8. The medium prior to entering the cavity comprising particulate and oils, or alternatively gases. Due to the higher density of the distilling medium of the medium with respect to the water safe oil 17, or gas, housed in the cavity 12, the water, or gas, from the medium 14 remains at a lower position in the cavity 12 with the water safe oil 17, or gas, housed in the cavity 12 dissociating from the water, or gas, from the medium 14 and allowing the water, or gas, from the medium 14 to lower in elevation in the cavity and drop towards the opening 8. Particulates from the medium 14 remain in or advance above the water safe oil 17, or gas, housed in the cavity 12. As a result of the lowered positioned, the water, or gas, from the medium 14 proceeds into and through the through hole 20 of the central mechanism 18. The water, or gas, from the medium 14 is filtered by the housed in the through hole 20. The distilled medium then advances through the tube 22 attached to the central mechanism 18 and away from the apparatus 3.

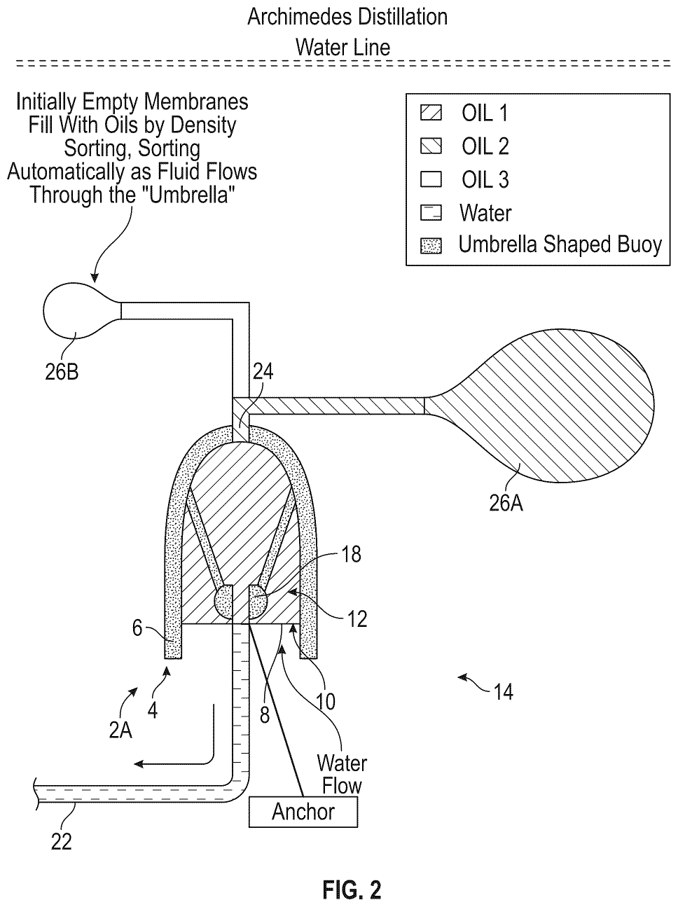

With attention to FIG. 2, is a side cross-sectional view of a second aspect of the distillation device of the invention 2A herein is illustrated. The second aspect of the distillation device of the invention 2A shares at least one feature with the first aspect of the distillation device 2. The second aspect of the distillation device 2A further provides for a shell opening (not illustrated in the figures) through the shell structure 6. The shell opening is preferably positioned opposite the opening 8, but may be positioned at any location along the shell structure 6. A second tube 24, having a second tube opening (not illustrated in the figures), mates with and extends from the shell opening such that the tube fits within or surrounds the shell opening. The second tube 24 extends away from the shell structure 6 in a direction preferably above the shell structure 6. The second tube 24 may extend in a direction that is partially or substantially above the opening 8. The second tube may partition and each such partition may end at a collection and fluidly connect to a collection container (26A, 26B).

In the method of applying the second aspect of the distillation device of the invention 2A, particulates and oils distilled, or gases, through the water safe oil 17, or gas, having a lower density than the water safe oil 17, or gas, exit the shell opening (not illustrated in the figures) through the shell structure 6. Such particulates and oils distilled, or gases, travel through the second tube 24 and are separated based upon density and enter either first collection container 26A or the second collection container 26B. In such process the distilled particulates and oils, or gases, of a first density reduce in movement away from the shell structure and house in the first collection container 26A. The distilled particulates and oils, or gases, of a second density proceed with the tube 24 to the second collection container 26B. It is understood the first density may be greater than the second density. Alternatively, the first density may be less than the second density, which becomes applicable where the collection containers (26A, 26B) are positioned below, or in proximity to a height of the opening 8 of, the second aspect of the distillation device 2A.

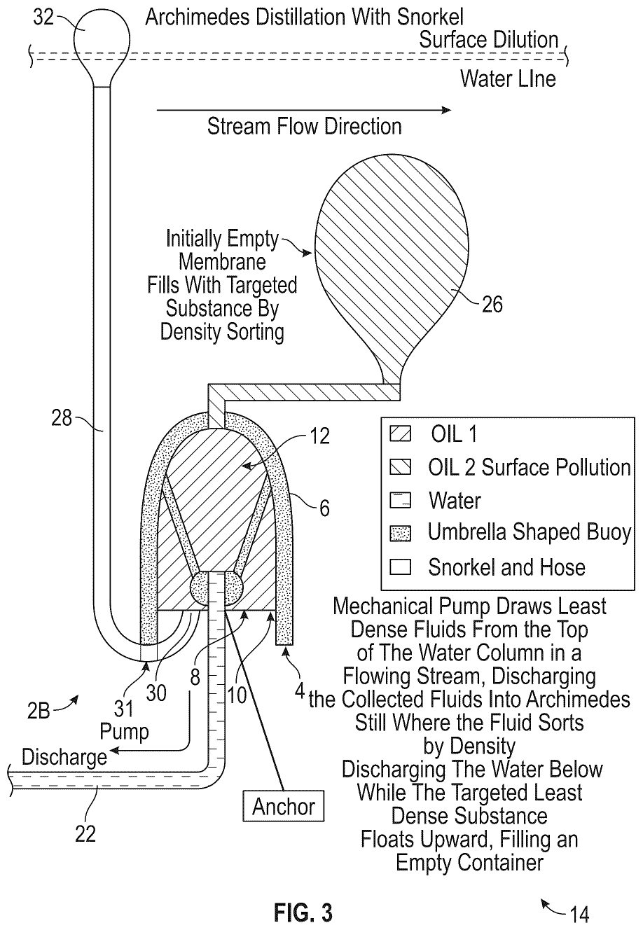

With attention to FIG. 3, a third aspect of the distillation device of the invention 2B herein is illustrated. The third aspect of the distillation device of the invention 2B shares at least one feature with at least one of the first aspect of the distillation device 2 and the second aspect of the distillation device 2A. In the third aspect of the distillation device 2B, a snorkel tube 28 is attached to the shell structure such that a first end 30 of the snorkel tube opens into the cavity at the opening, and a second end 32 extends to and opens at a location proximate to the water line. As such, the second end 32 receives water, and fluids, oils, and particulates less dense than the water, at or proximate to the water line. The subject water, and fluids, oils, and particulates less dense than the water, travel through the snorkel tube 28, specifically down the snorkel tube. At or proximate to the opening 8, a pump 31 is positioned to be operable within the snorkel tube 28. The pump 31 advances the subject water, and fluids, oils, and particulates less dense than the water, within the snorkel tube 28 into the cavity 12. The subject water, and fluids, oils, and particulates less dense than the water, are distilled as previously described.

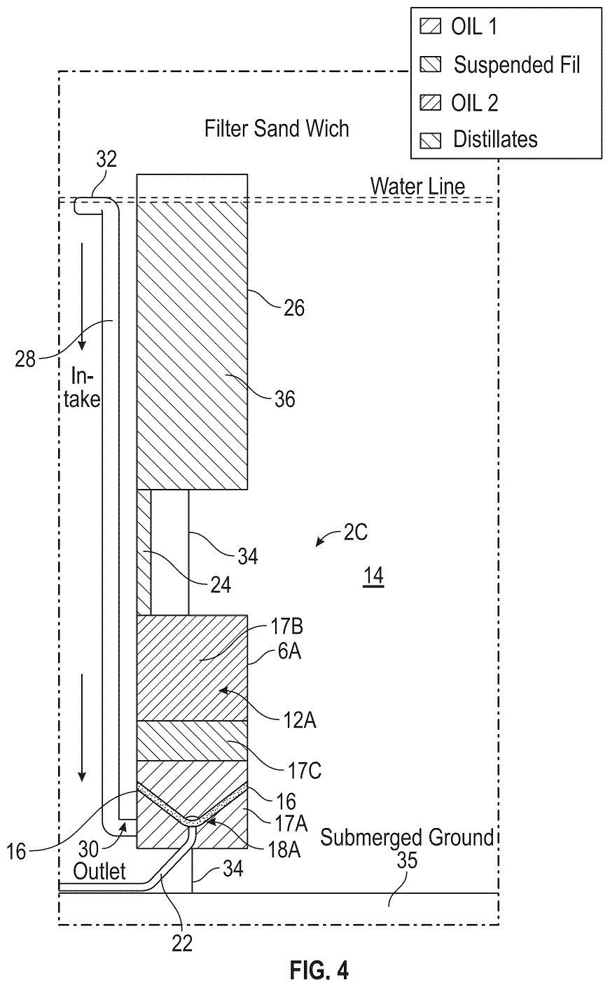

With attention to FIG. 4, a fourth aspect of the distillation device of the invention 2C herein is illustrated. The fourth aspect of the distillation device of the invention 2C shares at least one feature with at least one of the first aspect of the distillation device 2, the second aspect of the distillation device 2A, and the third aspect of the distillation device of the invention 2B. The distillation device 2C comprises a second aspect of the shell 6A. The shell 6A is a closed structure. It is observed the closed structure is preferably attached to the ground surface 35 with a tethering mechanism 34. Alternatively, the distillation device 2C may be buoyant in the medium 14. The shell 6A defines a cavity 12A. Radial supports 16 extend inward from the inner surface of the shell structure to a location in the cavity 12A. At the location in the cavity 12A, a central mechanism 18A is positioned. The central mechanism 18A comprises a through hole (not illustrated in the figures) through which the tube 22 is inserted. The tube 22 extends from the central mechanism 18A through an access port in the shell structure and extends away from the distillation device 2C. The tube transfers distilled water as previously described.

The cavity 12A houses a first water safe oil 17A, or gas, having a first density. The cavity additionally houses a second water safe oil 17B, or gas, having a second density. The second oil 17B has a density lower than the density of the first oil 17A, thus the first oil is positioned at a location in the cavity lower than that of the second oil 17B. With the cavity 12A, between the first oil 17A and the second oil 17B is positioned a suspended component 17C (nonlimiting examples being nanofilters, metal organic frameworks, binding agents, etc). The suspended component may be a third water safe oil, or gas having a density less than the first water safe oil 17A, or gas, but less than the second water safe oil 17A, or gas. Alternatively, the suspended component 17C may be a solid having a density less than the first water safe oil 17A, or gas, but less than the second water safe oil 17A, or gas.

A tube 24 extends from the shell 6A at least substantially distal with respect to the ground surface 35. The tube fluidly connects the shell 6A to a collection container 26. Additionally a snorkel tube 28, as previously described, may be fluidly connected to the shell with access to the cavity 12A. In operation, medium, containing oils, particulates, and gases, with a density different than the distilling medium carrying such in the medium travel down the tube 28 and into the cavity 12A. As previously described, for example the higher density distilling medium of the medium 14 travels to and through the tube 22. Lower density particulate, oils and gas distill or filter through the first oil 17A. The subject particulate, oils, and gases then are scrubbed or filtered by the suspended component. The remaining particulate, oils, and gas suspend through the second oil 17B. It is noted some of the particulate, oils, and gases do not exit the second oil 17B where such particulate, oils, and gases have a higher density than the second oil 17B. The resulting particulate, oils, and gases having a density lower than the second oil 17B travel through the tube 24 to the collection container 26. The collection container 26 may be retrieved for collection of such resulting particulate, oils, and gases.

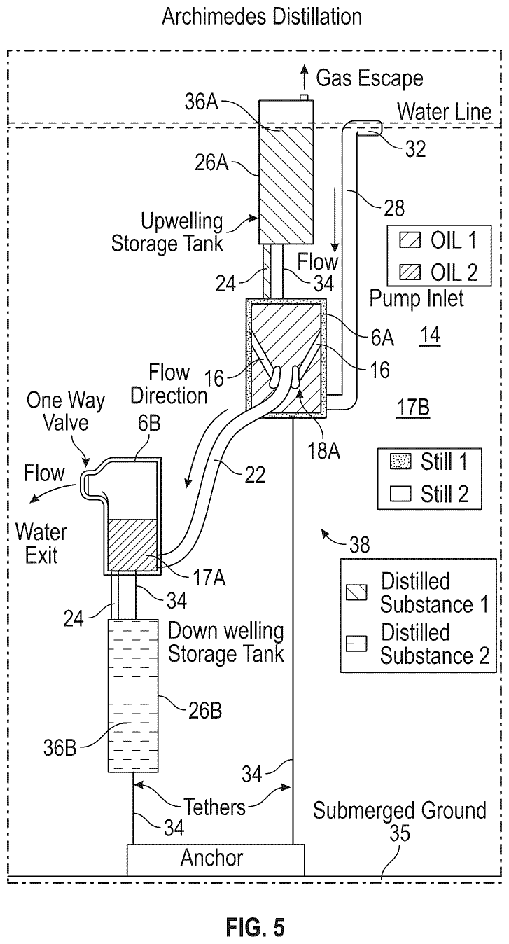

With attention to FIG. 5, a first aspect of a distillation system 38 incorporating the fourth aspect of the distillation device 2C of the invention herein is illustrated. The distillation system 38 illustrates the application of multiple distillation devices 2C. As illustrated in FIG. 5, first distillation device, having a shell 6A, is positioned near the surface of the medium 14. The first distillation device conducts the distillation applying the second oil 17B to collect a first precipitate, oil, and gas 36A in a first collection container 26A. The denser material, for example water, and precipitate, oil, and gas denser than that collected as the first precipitate, oil, and gas 36A, exit the shell 6A through a tube 22 and proceeds to a second distillation device, having a third aspect of the shell 6B. The material is distilled or filtered through the first oil 17A, which as has been explained is denser than the second oil 17B. The result being the water, and some precipitate, oils, and gas are less dense than the first oil 17A and exit the shell 6B above the first oil 17A in the shell 6B. Material, that being precipitate, oils, and gas, more dense than the first oil distill or filter through the first oil 17A and are collected in the second collection container 26B.

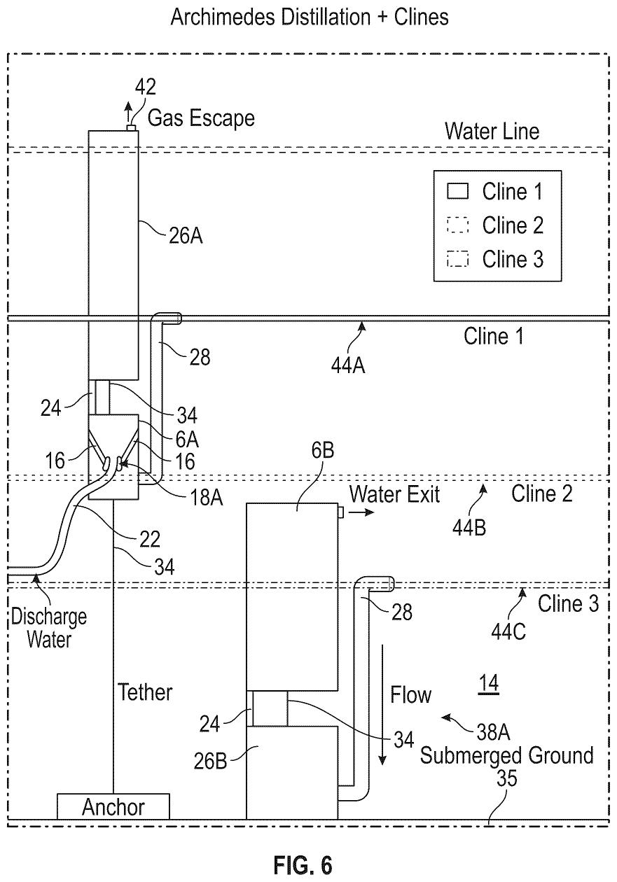

With attention to FIG. 6, the second aspect of the distillation system 38A illustrating the application of multiple units of the fourth aspect of the distillation device 2C of the invention herein, illustrating application as to various levels of a medium (44A, 44B, 44C). The various levels of the medium (44A, 44B, 44C) are cline, with each cline being a different gradation within the medium 14. In the second application of the system 38A, each distillation device 2C is self-contained and not fluidly connected to another distillation device 2C. Alternatively, the distillation devices 2C may be fluidly connected. The system 38A provides for collection of different precipitate, oils, and gases at the various clines (44A, 44B, 44C). Distillation devices can be placed in different strata within a stratified matter column to adopt the properties of that layer or a nearby layer for distillation. The distillation devices can be placed in and maintain positions within clines (horizontal strata within stratified water). Furthermore, the inlet that draws fluid into the distillation device can be positioned independently from the still itself, both gathering upwelling or downwelling fluids & syphoning or pumping fluid into the still for separation and harvesting. Thus, both the distillation device and the inlet can exist at any layer in a column and any layer in relation to each other. Thus, the distillation device and system may be constructed of different materials to operate at different depths within a medium. As such the pressure variation between medium depths may aid in density sorting. It is observed the system 38A allows for the escape of gases through the gas port 42. Further, a gas distillation device (2, 2A, 2B, 2C) as described may be placed in fluid connection with the gas port 42 in order to distill certain gases emitted from the gas port 42.

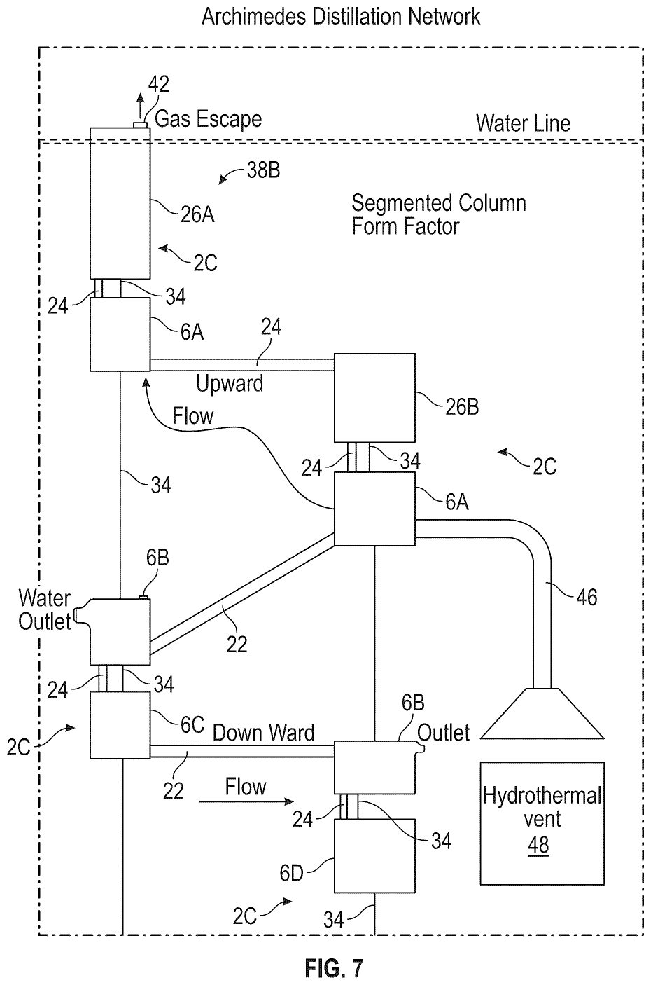

With attention to FIG. 7, a third aspect of the distillation system 38B illustrates application of the distillation system 38B at a hydrothermal vent. A vent hood 46 is placed over the hydrothermal vent 48. The vent hood 46 is intended to capture a percentage of the ejection from the hydrothermal vent 48. The ejection is then transferred through the hood 46 into the first distillation device 2C. As previous explained, multiple distillation devices 2C are connected fluidly in order to isolate precipitate, oils, and gases of various densities. Matter rising from hydrothermal vents may be harvested by the stack of distillation devices, with some anchored to the seabed and situated underwater mining matter from the plume upwelling through it. Additional distillation devices may be situated directly above the underwater ones, harvesting gases as they pass through. Additionally, hot springs and mineral springs have extremely peculiar chemistry which may be harvested by the distillation device and system of the invention.

Hydrothermal vents and volcanic gases contain complex mixtures of hot fluids. A system of distillation devices may be linked together via a network of pathways through which materials flow and various oils density sort the flow into different pathways. It may be advantageous for some of these pathways to change temperature during their journey, so that the winnowing process further sorts the matter that travels through the system. Tubing or pipes from a downstream portion of the system could double back to earlier parts of the system to convey heat or cold for thermoregulation of earlier parts in the network. A split loop system could have a MOF evaporation chamber with MOF tuned for a target type of matter, with the temperature swings to condense and evaporate the target material conveyed by the network as a heat exchanger. The operator may alternate between sides of the loop to achieve the swings needed for MOF harvesting. This heat exchanger strategy would be particularly interesting when harvesting matter from hydrothermal vents because the tubing may draw fluid through a series of stills at various layers in the stratified ocean. As material travels through this closed network of tubing, it cools and is exposed to different amounts of pressure, allowing different materials to be harvested at different depths. Once it has cooled, the material may loop back around to aid in thermoregulation.

A gas version of the distillation device may be positioned above gas emission ports, for example but not limited to smokestacks, chimneys, hydrothermal vents, cooling towers, and flues, to harvest exhaust gas, flue gas and/or other rising emissions. As such the distillation device may separate matter from the emissions. Thus, the distillation device may allow for pollutants to be mined from the emission port. Such an application of the distillation device may be applied to landfills. Specifically, the distillation device may be applied to gas ports which emit gas created during the decomposition of waste. The distillation device may distill pollutants emitted as part of the gas.

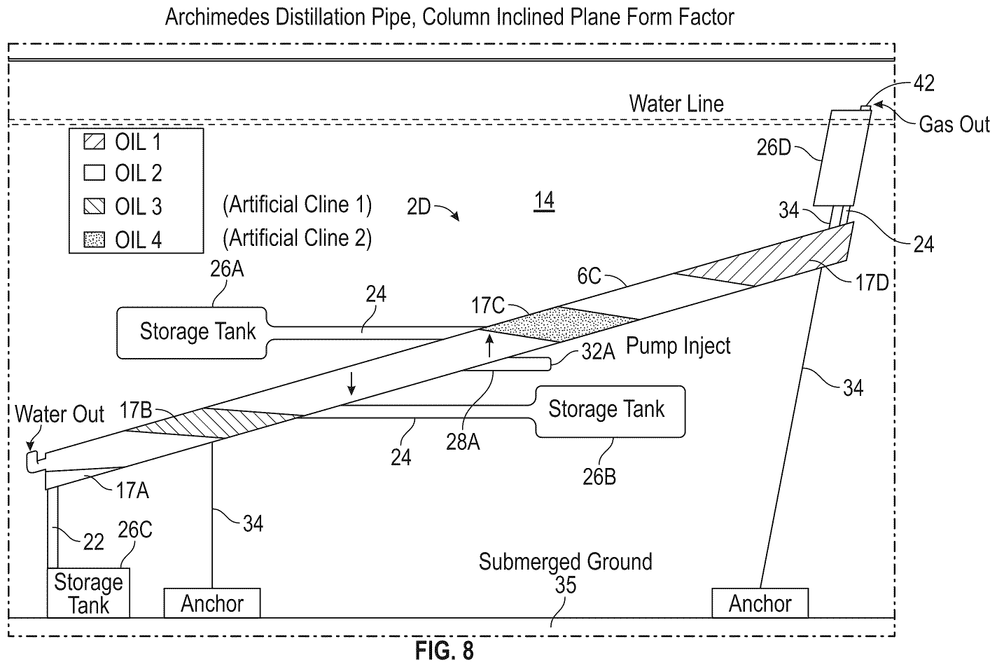

With attention to FIG. 8, a fifth aspect of the distillation device 2D of the invention herein is illustrated. The distillation device 2D comprises an elongated fourth aspect of the shell structure 6C. Medium 14 enters the cavity of the shell 6C through the opening 32A of the snorkel 28A and travels through the snorkel 28A. Within the cavity of the shell 6C medium fills the cavity and water safe oil, or gas, (17A, 17B, 17, or 17D) having different densities are positioned at various locations along the cavity where the shell 6C is angled with respect to a vertical position. Components, particulates, oils, and gases, of the medium that have entered the cavity as described separate based upon densities. Where a component is less dense than the second oil 17B the component enters the second collection container 26B. Where the component is greater in density than the second oil 17B the component passes through the second oil 17B. Where the component is then denser than the first oil 17A the component enters the third collection container 26C. An analogous effect happens for less dense components as the third oil 26C and the first collection container 26A, as well as the fourth oil 17D and the fourth collection container 26D.

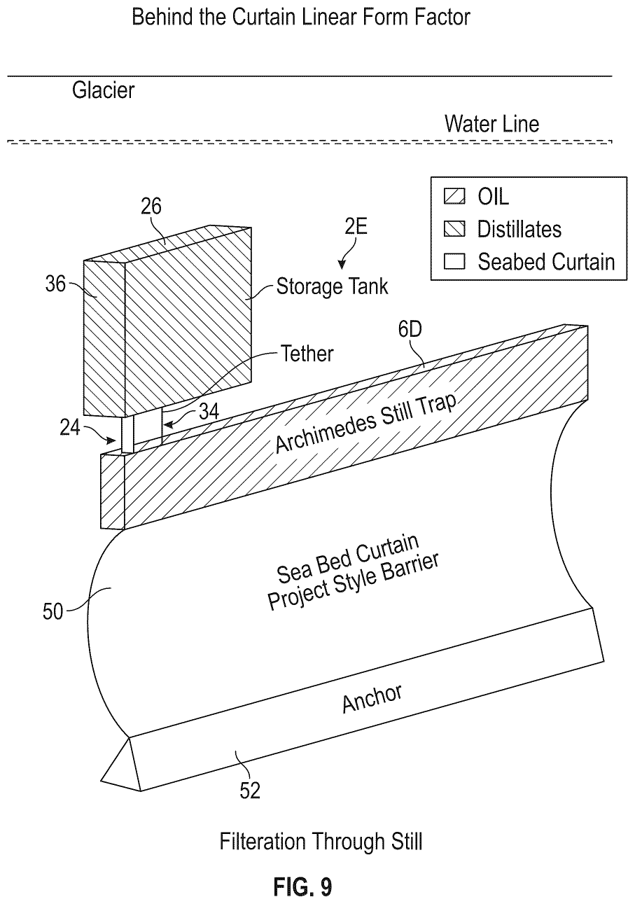

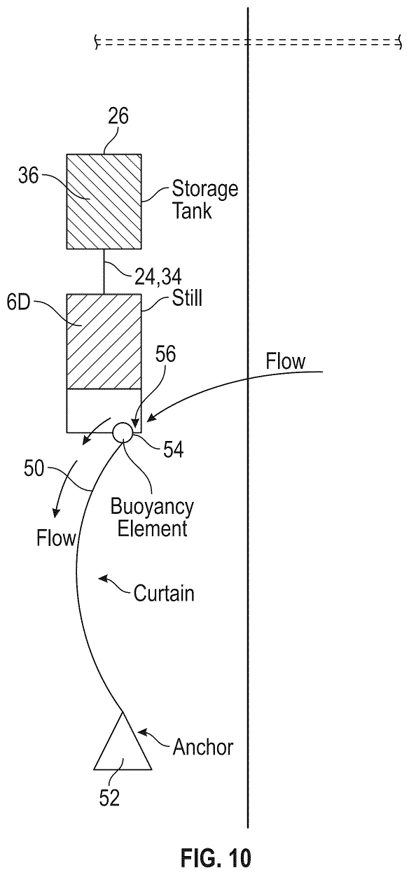

With attention to FIGS. 9 and 10 a sixth aspect of the distillation device 2E of the invention herein is illustrated. The distillation device 2E comprises a fifth aspect of the shell 6D. A collection container 26 is suspended via a tether 34 above the shell 6D and in fluid communication with the shell 6D, as previously described. A seabed collection curtain 50 extends below the shell 6D to the ground surface 35 and is anchored to the ground surface 35 with an anchor 52. As illustrated if FIG. 10, the collection curtain 50 is suspended at a corner of the shell 6D with a curtain buoy 54. The position of the curtain buoy 54 with respect to the shell 6D provides for a flow gap 56 between the oil 17 in the shell 6D and the base of the shell 6D. Medium flows into the flow gap and out the shell 6D. In the process, particulate, oils, and gases are distilled or filtered through the oil 17 and stored in the collection container 26.

Each distillation device (2, 2A, 2B, 2C, 2D, 2E) and system (38, 38A, 38B) may be understood to share and/or incorporate at least one feature of at least one of the remaining distillation devices (2, 2A, 2B, 2C, 2D, 2E) and/or systems (38, 38A, 38B). The distillation device (2, 2A, 2B, 2C, 2D, 2E) and systems (38, 38A, 38B) are understood to be programmable systems allowing for a smart system which can maintain the distillation device(s) at a certain depth within the medium column and the intake or intakes (32, 32A) at a certain depth within the medium column. This could be achieved by modifying the density of the ballast or buoyancy of the still or allowing it to rise and fall in height via a tether, allowing it to adapt to the rise and fall of tides, changes in salinity and water temperature, environmental conditions, etc. Programmability could include machine learning and artificial intelligence to forecast when conditions will change and optimize the system accordingly, and perhaps create forecasts of how much matter will be harvested and how much the harvested matter could sell for. Programmability may also extend to smart thermostats, matter sensors, mechanical flushes, automatically refilling the oil layers, buoyancy within a column essentially automating or computerizing all of the functions of the distillation device and system. Programmability may be extended across different states of matter (and phase changes), different elements and compounds under different conditions. The end result would ideally manifest as controls and variables that an end user could select to obtain targeted distillates.

The distillation device and system may be placed within a controlled environment and the conditions within the container are controlled independently of the still itself, each having separate controls and variables. The application of the distillation device and system may extend to space-based versions. The distillation device and system may be used to harvest mercury from hot springs and water treatment plants. The distillation device and system may be used in brine mining to harvest matter concentrated in haloclines. The distillation device and system may be used to pre-filter salt water for desalination intakes by pulling water from less salty strata layers.

The distillation device and system may be coupled with tidal energy generators, floating wind turbines, traditional (prior art) buoys, oil platforms or other ocean and sea-based infrastructure to harvest distillates from the environment. Further, the distillation device and system may be applied adapting this technology in such a way that it could be used by oil tankers to force large volumes of fluid to rapidly density sort and separate oil from seawater and divert the oil into containers aboard the bulk transporter.

In the event of oil and chemical spills, the distillation device and system may be applied allowing oil tankers to force large volumes of fluid to rapidly density sort and separate oil from seawater and divert the oil into containers aboard the bulk transporter. In doing so, the distillation device and system may apply a long flow line that has a ballast or anchor that keeps the bottom of the loop at depth. The flow line beneath the shell structure would be stretched vertically for some distance so that the oil had time to density sort as it flowed through the line. Oil spill and chemical spill clean ups may use containment booms to concentrate and position floating medium part of such spill. The intake of the distillation device may be placed within the area defined by the containment boom from which the distillation device may draw the medium into the distillation device.

The distillation device and system may be applied using aircraft. Such distillation devices and systems may be applied to harvest pollutants that flow through certain areas. The distillation device and system may be untethered, designed to harvest expensive gases from different layers of the atmosphere (like xenon) at various heights and return the harvested gas to the surface as a product. It is possible, theoretically, that a long hose dangling downward far from the umbrella shaped buoy in the sky, could utilize Bernoulli's principle, or some other process, to passively create airflow that caused air to flow through the system. Such a device may apply an empty container that could be filled with the target gas, a method for dropping the gas filled container back to land and a method for returning it to a processing center for further refinement and sale.

The distillation device and system may have heating and/or cooling capabilities and perhaps a thermostat to maintain or adjust the temperature of the material in the trap. This would allow the system to maintain ideal density sorting conditions and respond to changes in atmospheric pressure, tidal flows, temperature swings, etc. It could also be used to stop the process, turning it off. The oil floats to the top or bottom of the inside of the shell of the distillation device while the distilling medium, water or gas, is filtered through the oil. The flow oil and distilling medium is such that each travels with as little agitation as possible to limit, reduce or eliminate the chance of forming an emulsion. Unlike the distillation systems of the prior art, the distillation devices of the invention allow for upward sorting & harvesting and downward sorting & harvesting. A float (not illustrated in the figures) may be applied that is capable of responding to changes in the level of oil in the distillation device. The float mechanism may be joined to one or both the opening and second tube opening of the shell of the distillation device so that each float remains immersed in the oil layer as the distillation device fills with the distilled medium and then empties upon flushing into collection container by some manner of valve.

The distillation device and system may be constructed out of ice (perhaps using frozen molds or 3d printing). Such a device would depend heavily on an oil material that would allow density sorting at very low temperatures.

The distillation device and system may apply at least one loop of transparent tubing on or near the surface of water to allow sunlight in to take advantage of photodegradation.

The distillation device and system may comprise a ballast tank to alter the weight or stability of the structure in fluid. The ballast tank makes the distillation device and system neutrally buoyant in the chosen medium or it could be firmly anchored in place.

It is understood the distillation device and system may apply other formers of matter known in the art as the distillation medium, beyond oil. Such includes plasma. The density, specific gravity, and cohesive forces of the material used as the distillation medium shall allow for distillation of material which has entered the distillation medium. A reason for such separation is that distillation medium shall have at least one of a different density than the material entering the distillation medium, a different specific gravity than such material entering the distillation medium, and cohesive forces of a degree to prevent bonding between the distillation medium and the material entering the distillation medium.

The distillation device may be coupled with tidal energy generators, floating wind turbines, traditional (prior art) buoys, oil platforms or other ocean and sea-based infrastructure to harvest distillates from the environment. The distillation device may be applied to act in conjunction with a service operator to harvest precious metals, such as but not limited to gold, silver and platinum. The operator may hold onto the harvested metals for the customer and store such until the customer wished to sell the metals. The operator may cast distillate gases in or into a solid (such as but not limited to xenon gas within glass or metallic glass) for trading. Thus, the distillation device may allow the patent owner to integrate the flow of matter from before distillation to the market after purification.

A construction of the distillation device 2 may be used to extract contaminants (for example lithium) from wastewater. Such wastewater may be for example fracking wastewater or produced water or other types of wastewater.

A construction of the distillation device 2 may separate and/or filter per- and polyfluoroalkyl substances (PFAS) to provide for an improved system and method of separating such pollution from the environment. For example, landfill gas emissions may be a significant source of PFAS pollution. A construction of the distillation device 2 may be deployed at landfills or similar water containment and/or processing structures and facilities to harvest, filter and sequester PFAS pollution.

Existing radon mitigation strategies, infrastructure and equipment could be augmented with a construction of the distillation device 2 to harvest and/or remove radon (and potentially other trace elements and compounds) from water and living spaces.

Further, Xenon and other trace elements and compounds may be emitted from cooling water and exhaust from nuclear reactors. A construction of the distillation device 2 may be applied at such facilities to harvest the resource.

In addition to being deployed in water, on land or in the air/atmosphere, a construction of the distillation device 2 may be hybridized to create a flow network through which matter could flow that was placed partially on land, partially in water or partially in air.

A construction of the distillation device 2 may be portable, portable in that the device 2 may be repositioned from a first location to a second location. Such a portability allows the device 2 to be applied in concurrent or consecutive chemical spill remediations, and/or temporary seasonal waterway flows. A portable construction of the device 2 could be mounted on cargo carriers (for example: tractor trailers, trains, trucks). In doing so the device 2 is placed within fluid containers (such as tanker trailers or tanker rail cars) or on or within intermodal shipping containers. For example, the portable construction of the device 2, when deployed among intermodal shipping containers, may be stacked vertically manually or mechanically, for example a reacher grabber unit, to create the vertical drop as previously described for distillation. Portable constructions of the device 2 may be positioned on a plane, for example an inclined plane, to facilitate the vertical drop as previously described for distillation. Portable constructions of the device 2 may be housed in, mounted upon, rest upon or be held/contained by a mechanical apparatus to angle the device 2 and/or distilled medium onto an inclined plane.

A construction of the distillation device 2 may positioned in, positioned on, or positioned adjacent to dams and/or other fluid retaining infrastructure, allowing operators to distill gas, air, fluid, and/or particulate from the reservoir or perhaps distilling fluids as the water flows through the structure.

Corridors for mining, ventilation, water movement, sewage movement and/or human access may have flooded with water and become contaminated by mining tailing, sewage, seawater, or other pollution sources. These corridors may be applied as avenues for movement of distilled medium in a network interconnected distillation devices 2.

Geothermal plants convey fluids from within the earth to a terrestrial plant where heat exchanging occurs. A construction of the distillation device 2 may distill gas, air, fluid, and/or particulate from geothermal plant locations.

In compressed air energy storage, as matter flows into or out of a mechanism to compress or decompress air for energy storage purposes, a construction of the distillation device 2 may distill the gas, air, fluid, and/or particulate in the air which is compressed or to be compressed.

A construction of the distillation device 2 may be applied to harvest gas, air, fluid, and/or particulate from the deployment of industrial fermentation devices and processes.

It is understood that the distillation devices of the invention may operate using upwelling distillation, where medium 14 this is filtered such that the particulates, oils, and gases of the medium 14 rise to a level in the device above the remainder of the distilling medium. Further, it is understood the distillation devices of the invention may operate using downwelling distillation, where medium 14 this is filtered such that the particulates, oils, and gases of the medium 14 fall to a lower level in the device than the remainder of the distilling medium. Further the distillation devices of the invention require significantly fewer energy inputs to function for the distillation devices of the invention operate with principle application of gravity. Energy input is required for fewer aspects of the distillation device as compared to that of those known in the art. For example in the devices of the invention, energy may be required merely for a pump 31 to start a syphon, a pump 31 to move fluids for heat exchanging purposes and the embodied energy used to make the oil and the apparatus. In some cases, like xenon extraction, the distillation devices of the invention may significantly reduce the cost of production because the distillation devices of the invention may significantly reduce the energy input and have a positive environmental impact.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A distillation device, comprising:
a shell defining a cavity;
a solution positioned in the cavity, with the solution being of a first density;
a first opening for addition of a distilling medium to the solution with the distilling medium having a second density;
a second opening positioned lower than the first opening, with the second opening defined by a support mechanism, with the support mechanism attached to the shell; and
the second opening providing for an exit of the distilling medium.

2. The distillation device of claim 1, wherein in the shell has a curved shape.

3. The distillation device of claim 2, wherein the curved shape is concave with respect to a surface, with the curved shape being a parabolic shape.

4. The distillation device of claim 1, wherein the solution is one of a gas and an oil.

5. The distillation device of claim 1, wherein having a second solution having a third density for suspension of a distilling medium component having a fourth density, with the fourth density being less than the third density.

6. This distillation device of claim 5, wherein the third density is less than the second density.

7. The distillation device of claim 1, further comprising a pump for insertion of the distilling medium into the solution.

8. The distillation device of claim 1, wherein in the support mechanism is one or more tethers extended from the shell.

9. The distillation device of claim 1, wherein the first opening is connected to an extension having an opening positioned proximate to a fluid line of a fluid in which the distillation device is positioned.

10. The distillation device of claim 1, wherein the shell is fluidly connected to a plurality of solutions, with each solution of the plurality of solutions having a different density.

11. The distillation device of claim 10, wherein a first distilling medium component having a first distilling medium component density is suspended in a first solution of the plurality of solutions and a second distilling medium component having a second distilling medium component density is suspended in a second solution of the plurality of solutions.

12. The distillation device of claim 1, wherein the shell is a tubular structure.

13. A system of distillation, comprising:
a plurality of distillation devices, with each of the plurality of distillation devices having:
a shell defining a cavity;
a solution positioned in the cavity, with the solution being of a first density;
a first opening for addition of a distillation medium to the solution with the distillation medium having a second density;
a second opening positioned lower than the first opening, with the second opening defined by a support mechanism, with the support mechanism connected to the shell; and
the second opening providing for an exit of the distilling medium; and
each of the plurality of distillation devices in fluid connection.

14. The system of distillation of claim 13, wherein the plurality of distillation devices are positioned in a substantially vertical orientation.

15. The system of distillation of claim 13, wherein a first distillation device is positioned closer to a ground than a second distillation device, with the first distillation device having a first distilling medium component and the second distillation device having a second distillation medium component, with the first distillation medium component having a greater density than the second distillation medium component.

16. The system of distillation of claim 13, wherein has a gas port for a removal of gas.

17. The system of distillation of claim 13, wherein the system having a vent hood for capture of the distillation medium.

18. A method of distillation, comprising:
advancing a distillation medium to an opening of a shell of a distillation device;
inserting the distillation medium in a solution positioned in a cavity defined by the shell, with the solution being of a first density;
separating a first component of the distillation medium having a second density from a second component of the distillation medium having a third density;
pushing the first component of the distillation medium lower than the solution to a mechanism supported by the shell for a removal of the first component of the distillation medium; and
housing the second component of the distillation medium one of with or above the solution.

19. The method of distillation of claim 18, wherein the pushing the first component of the distillation medium lower than the solution comprises the second density being greater than the first density.

20. The method of distillation of claim 18, wherein the housing the second component of the distillation medium one of with or above the solution comprises the first density being greater than the third density.
